(19) United States
(12) Patent Application Publication
(10) Pub. No.: US 2020/0201513 A1
(43) Pub. Date: Jun. 25, 2020

(54) SYSTEMS AND METHODS FOR RFID TAG LOCATIONING IN AUGMENTED REALITY DISPLAY

(71) Applicant: Zebra Technologies Corporation, Lincolnshire, IL (US)

(72) Inventors: Eric M. Malmed, Selden, NY (US); David D. Landron, Coram, NY (US)

(21) Appl. No.: 16/229,205

(22) Filed: Dec. 21, 2018

(51) Int. Cl. G06F 3/0481; G06T 19/00; G06F 16/58; G06F 9/30; G06K 7/10

(52) U.S. Cl. CPC G06F 3/04815; G06T 19/006; G06K 7/10099; G06F 9/3004; G06F 16/58

(57) ABSTRACT

Systems and methods are provided for identifying an item in a inventory environment, by generating an augmented reality display of that environment, where that display includes an image identifier that points to a location of the item in that environment. The image identifier is generated by an augmented reality assembly, such as augmented reality glasses or a handheld barcode scanner with digital display. The augmented reality assembly may determine the location of the item, by detecting and tracking an electronic tag (passive or active) associated with the item. With the tag detected and tracked, the augmented reality assembly can generate the image identifier and place the image identifier in an augmented reality display of the inventory environment to identify to a user the location of that tag.

### BACKGROUND

In an inventory environment, such as a retail store, a warehouse, a shipping facility, etc., tracking of items is important. Commonly, items are tracked using some type of passive or active tracking modality, such as radio frequency identification (RFID) systems. In RFID systems, items, such as packages or goods in a retail environment include a passive or active RFID that is used as a beacon to positionally locate the attendant item and track movement and placement of that item throughout the retail environment. While RFID systems can be used to locate items with relative accuracy, in a geo-locating sense, there are no effective ways of visually displaying to employees where an identified item is with the inventory environment. Indeed, there is a need for an effective way of displaying RFID-identified items using an augmented display or virtual display, for faster and more accurate tracking of items.

### BRIEF DESCRIPTION OF THE SEVERAL VIEWS OF THE DRAWINGS

FIG. 1 is a block diagram of augmented reality assembly that may be used to track an electronic tagged item and display a graphic indicating a location of that item, in accordance an example implementation.

FIGS. 2A and 2B illustrate an example augmented reality assembly of FIG. 1 in the form of wearable augmented reality glasses, in accordance with an example.

FIG. 3 illustrates the example augmented reality glasses of FIGS. 2A and 2B mounted to a head of a user, in accordance with an example implementation.

FIG. 4 is a flowchart of example process of tracking an electronic tagged item and displaying a graphic indicating a location of that tracked item, in accordance with an example implementation.

FIGS. 5-7 illustrate augmented reality displays providing graphics each indicating a location of a different tracked item, as may be generated by the process of FIG. 4 implemented using augmented reality glasses as the augmented reality assembly, in accordance with an example implementation.

FIGS. 8 and 9 illustrate augmented reality displays providing a graphic indicating the location of a tracked item (FIG. 8) or multiple graphics indicating locations of multiple tracked items (FIG. 9), and as may be generated by the process of FIG. 4 implemented using a handheld scanner as the augmented reality assembly, in accordance with an example implementation.

FIG. 10 is a block diagram of system having a locationing server that may be used to track an electronic tagged item and a presentation generator for displaying an augmented reality display indicating the location of the tracked item, in accordance an example implementation.

FIG. 11 is a block diagram representative of an example processing device configured to implement example methods and apparatus disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present teachings.

The apparatus and method components have been represented where appropriate by conventional symbols in the drawings, showing only those specific details that are pertinent to understanding teachings of this disclosure so as not to obscure the disclosure with details that will be readily apparent to those of ordinary skill in the art having the benefit of the description herein.

### DETAILED DESCRIPTION

Systems and methods are provided for identifying an item in an inventory environment, by generating an augmented reality display of that environment, where that display includes an image identifier that points to a location of the item in that environment. The image identifier is generated by an augmented reality assembly, such as augmented reality glasses or a handheld RFID reader with digital display. The augmented reality assembly may determine the location of the item, by detecting and tracking an electronic tag (passive or active) associated with the item. With the tag detected and tracked, the augmented reality assembly can generate the image identifier and place the image identifier in an augmented reality display of the inventory environment to identify to a user the location of that tag, and thus the item. In some examples, the augmented reality assembly includes a radio-frequency identification (RFID) reader to detect and track RFID tags for items of interest.

In some examples, the system includes an augmented reality assembly comprising a presentation generator configured to display an augmented reality display to a user. The presentation generator includes a tag reader configured to locate and track a tag associated with the item, a tag locationer configured to determine a location of the tag in a three-dimensional (3D) space, a presentation generator locationer configured to determine a location of the presentation generator in the 3D space, a map generator configured to generate a special mapping of the location of the tag in the 3D space, an image generator configured to generate the image identifier, and a display. The presentation generator may further include a memory configured to store computer executable instructions; and a processor configured to interface with the memory, and configured to execute the computer executable instructions to cause the augmented reality assembly to, identify the tag in the inventory environment, determine a location of the tag in the inventory environment, generate an image identifier, and display the image identifier in an augmented reality display, where the image identifier identifies the location of the tag in the inventory environment.

In some examples, a system is provided for displaying an image identifier associated with an item in an inventory environment. The system includes a locationing server communicating with one or more locationing stations positioned within an inventory environment, each locationing station configured to detect a tag associated with the item within the inventory environment, the locationing server configured to determine a location of the tag within the inventory environment. The system further includes an augmented reality assembly communicatively coupled to the locationing server to receive location data for the tag. The augmented reality assembly includes a presentation generator configured to display an augmented reality display a user, where the presentation generator comprises, a presentation generator locationer configured to determine a location of the presentation generator in a 3D space of the inventory environment, a map generator configured to generate a mapping of the location of the tag in the 3D space, an image generator configured to generate the image identifier, and a display. The augmented reality assembly further includes a memory configured to store computer executable instructions; and a processor configured to interface with the memory, and configured to execute the computer executable instructions to cause the augmented reality assembly to, determine a location of the tag in the 3D space, generate an image identifier, and display the image identifier in an augmented reality display of the 3D space, where the image identifier identifies the location of the tag in the inventory environment.

In some examples, an augmented reality display system includes: a display configured to display an augmented reality rendition of an inventory environment to a user; an RFID tag reader configured to detect and track one or more RFID tags in the inventory environment; a memory configured to store computer executable instructions; and a processor configured to interface with the memory, and configured to execute the computer executable instructions to cause the augmented reality display system to, in response to detection and tracking of one or more RFID tags, generate for each detected RFID tag an image identifier, and generating the augmented reality rendition of the inventory environment having the image identifier for each detected RFID tag, where the location of the image identifier indicates a location of the detected RFID tag in the inventory environment.

In some examples, a computer-implemented method for displaying an image identifier associated with an item in an inventory environment, the method includes: in an augmented reality display assembly, detecting and tracking a RFID tag in the inventory environment, generating an image identifier for the RFID tag, and generating an augmented reality display of the inventory environment, where the image identifier is placed within the augmented reality display to indicate a location of the detected RFID tag in the inventory environment.

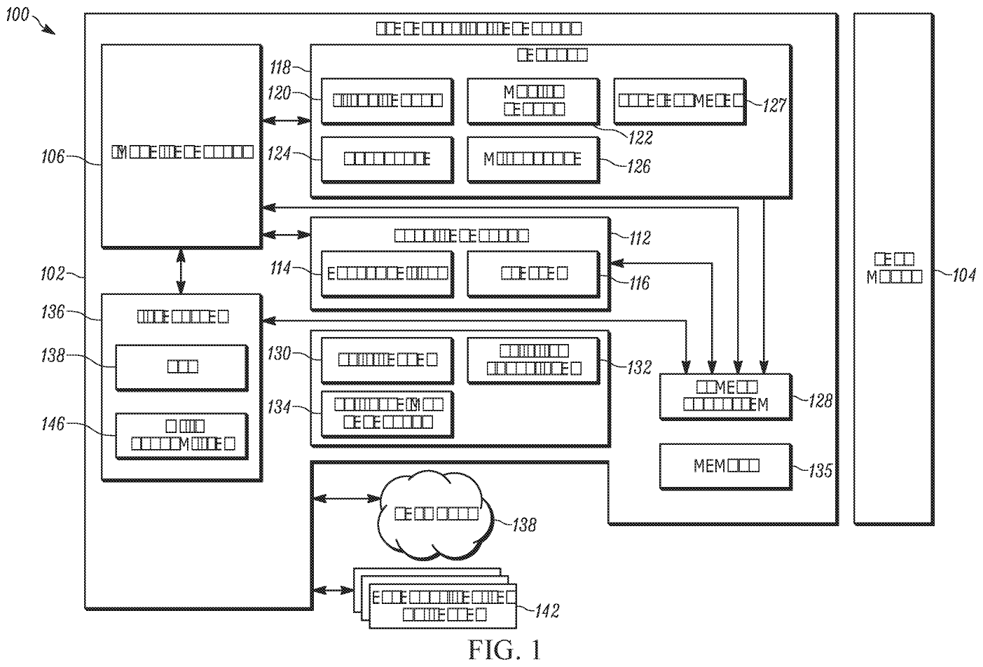

FIG. 1 is a block diagram of an example augmented reality assembly 100 constructed in accordance with teachings of this disclosure. Alternative implementations of the example augmented reality assembly 100 of FIG. 1 include one or more additional or alternative elements, processes and/or devices. In some examples, one or more of the elements, processes and/or devices of the example augmented reality assembly 100 of FIG. 1 may be combined, divided, re-arranged or omitted.

The example augmented reality assembly 100 of FIG. 1 includes a presentation generator 102 and a head mount 104. The head mount 104 is constructed to mount the presentation generator 102 to a head of a person such that a presentation generated by the presentation generator 102 is consumable by the person. The presentation includes visual media components (e.g., images) and/or audio media components. To generate images such as static or animated text and/or graphics, the example presentation generator 102 of FIG. 1 includes an image generator 106. The example image generator 106 of FIG. 1 is in communication with one or more sources of image data. The image data received at the image generator 106 is representative of, for example, text, graphics and/or augmented reality elements (e.g., information overlaid on objects within the field of view). The image data may be one or more graphics to be displayed to users at locations that correspond to items identified in an inventory environment. As discussed, these may be items may be identified using an RFID locationing system or other locationing modality.

In some examples, the image generator 106 includes light engines that convert received image data into patterns and pulses of light. For example, these light engines (e.g., light emitting diodes (LEDs)) may generate images and communicate generated light to a waveguide, such that the images corresponding to the received data are displayed to the user via the waveguide. In some examples, the light engines include optics that condition or manipulate (e.g., polarize and/or collimate) the generated light prior to providing the light to the waveguide. The example image generator 106 may employ any suitable image generating technology such as, for example, cathode ray tube (CRT) devices or scanning lasers.

The image generator 106 generates images in a direction, orientation, size, color, and/or pattern corresponding to a particular location in a field of view and thus corresponding to a particular focal distance based on the location of the items, where each generated image may be different from one another to identify the different items.

The image generator 106 may include waveguides having lenses, gratings, or reflectors to refract, diffract or otherwise direct the generated images towards an eye of the user, thereby displaying the images to the user. In the illustrated example, the image generator 106 (e.g., waveguides) may be transparent such that the user can view surroundings simultaneously with the displayed image(s) forming an augmented reality view, or the surroundings only when no image is displayed.

The example presentation generator 102 of FIG. 1 includes an audio generator 112 that receives audio data and converts the audio data into sound via an earphone jack 114 and/or a speaker 116. In some examples, the audio generator 112 and the image generator 106 cooperate to generate an audiovisual presentation, such as providing a visual indication and an audio indication of the location of items identified in the inventory environment.

In the example of FIG. 1, the example presentation generator 102 includes (e.g., houses and/or carries) a plurality of sensors 118. In the example of FIG. 1, the plurality of sensors 118 include a light sensor 122, a motion sensor 124 (e.g., an accelerometer), a gyroscope 126, accelerometer 127, and a microphone 128.

In some examples, the presentation generated by the image generator 106 and/or the audio generator 112 is affected by one or more measurements and/or detections generated by one or more of the sensors 118. For example, a characteristic (e.g., degree of opacity) of the images generated by the image generator 106 may depend on an intensity of ambient light detected by the light sensor 120. More generally, the location of the images to be displayed to the user may vary depending on the location and movement of the presentation generator 102, as determined from the gyroscope 126, motion sensor 122, and/or accelerometer 127, as well as in addition to the location of the item. Further visual characteristics of the image may depend on the output of the sensors 118, such, as the color, size, and/or animation of the image. As an item gets closer to the presentation generator 102, for example, the image generator 106 may change the color if the image identifying the item in the augmented field of view.

Additionally or alternatively, one or more modes, operating parameters, or settings are determined by measurements and/or detections generated by one or more of the sensors 118. For example, the presentation generator 102 may change the visual display mode depending on the position of the item relative to the position of the presentation generator 102 a standby mode if the motion sensor 122 has not detected motion in a threshold amount of time.

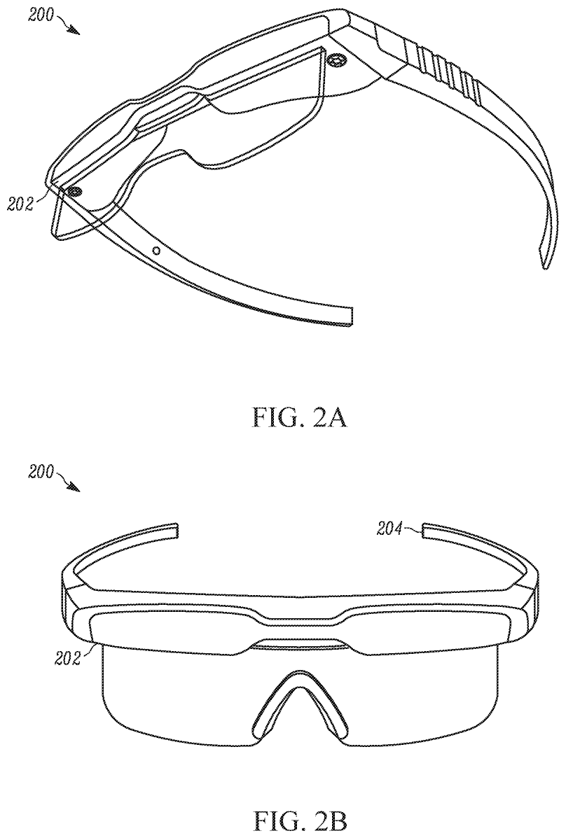

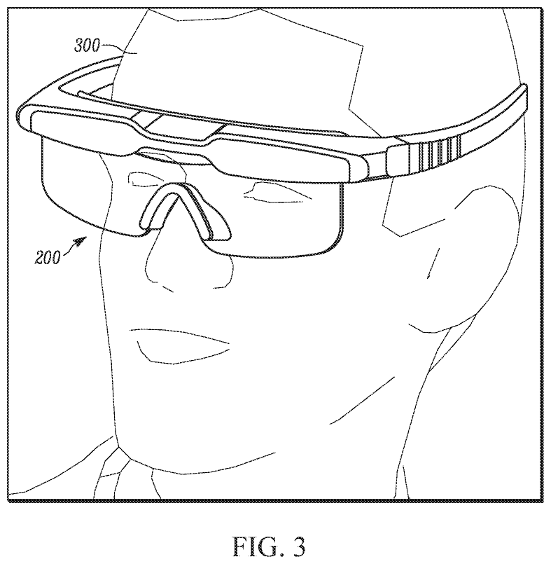

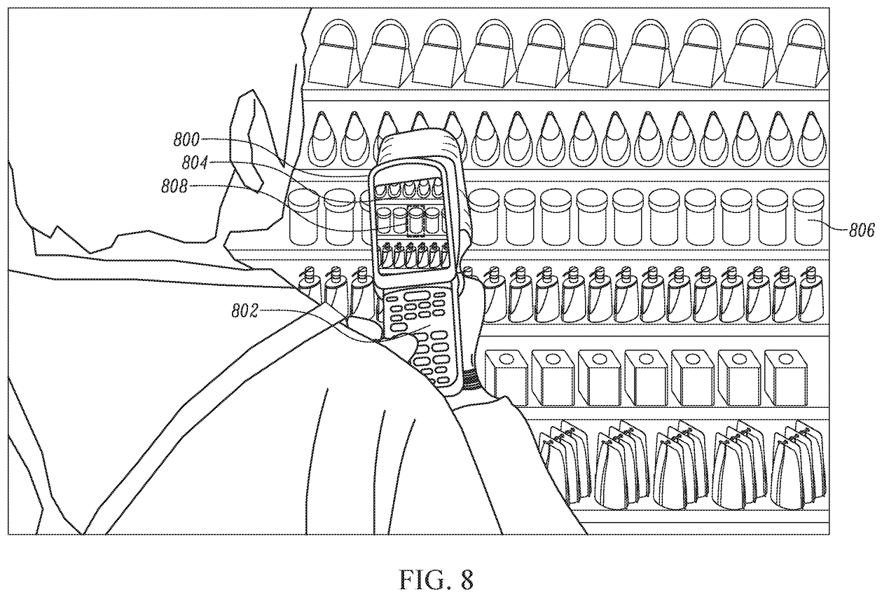

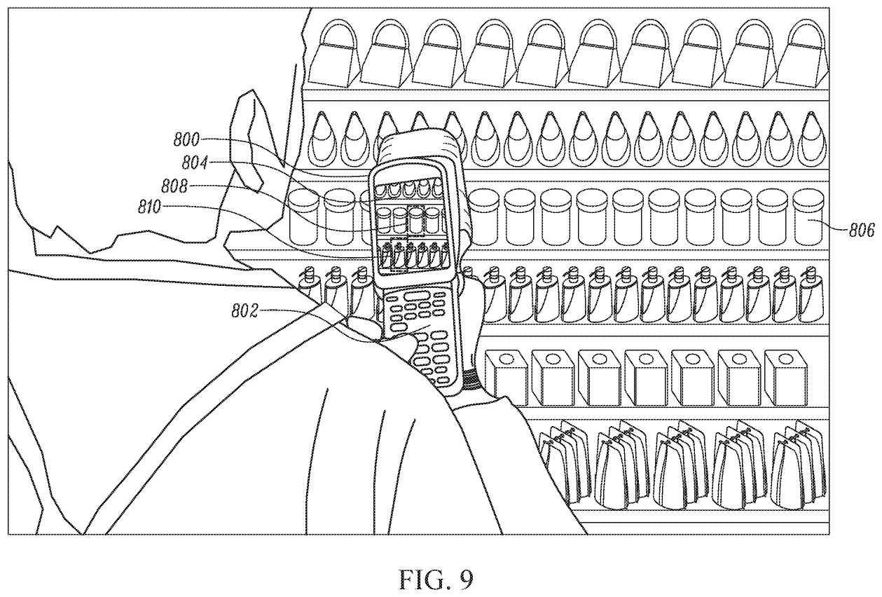

The presentation generator 102 may be implemented in any number of augmented reality displays. For example, in exemplary embodiments, the presentation generator 102 may be implemented as a heads up display unit, such as augmented reality glasses 200, shown in FIGS. 2A, 2B, and 3. In other exemplary embodiments, the presentation generator 102 may be implemented as a handheld device, such as a handheld scanner 800, shown in FIGS. 8 and 9.

In the illustrated example, the presentation generator 102 includes an optional camera sub-system 128. The camera sub-system 128 may be mounted to or carried by the same housing as the presentation generator 102. In some examples, the camera sub-system 128 is mounted to or carried by the head mount 104. The example camera sub-system 128 may include one or more cameras and a microphone to capture image data and audio data, respectively, representative of an environment surrounding the augmented reality assembly 100. The image data of the environment can then be augmented by the image generator 106 to include images identifying the location of items in the environment. In some examples, the camera sub-system 128 includes one or more cameras to capture image data representative of a user of the augmented reality assembly 100 (such as the eyes or the face of the user) for displaying that data via the presentation generator 102 or for sending that information to a server.

Images generated by the image generator 106, images captured by the camera subsystem 128, captured audio data, and other data may be stored in memory 135 of the augmented reality assembly 100. In some examples, various data may be communicated to an external device or server 142 through an interface 136, such as a wired interface, such as a universal serial bus (USB) interface 138, or through a wireless interface, such as a WIFI transceiver 140 or other wireless communication interface communicating over a network 144. The interfaces 136 may further include a Bluetooth® audio transmitter for communicating audio signals to the headphones or a speaker of the user of the presentation generator 102, for example, audio signals indicating a relative location of an item of interest. The external device or server 142 may represent multiple devices, including keypads, Bluetooth® click buttons, smart watches, and mobile computing devices, as well servers. The servers may include or be part of inventory manager controllers. The servers may communicate with or include locationing systems for identifying RFID tags and other assets within an inventory environment. In some examples, the locationing systems include one or more overhead cameras or locationing transceivers, such as RFID readers, RF transceivers, infrared locators, Bluetooth® transceivers, for tracking items within the inventory environment.

The presentation generator 102 further includes an RFID reader 130 for identifying items of interest in an inventory environment, in particular, by identifying an RFID tag associated with each item of interest. The RFID reader 130 may include an RFID antenna, and the RFID reader 130 may be configured to emit, via the RFID antenna, a radiation pattern, where the radiation pattern is configured to extend over an effective reading range within an inventory environment to identify and read one or more RFID tags. In exemplary embodiments, the presentation generator 102 instructs the RFID reader 130 to identify only certain RFID tags, such as RFID tags corresponding to items identified by an external device or server 142. The identified items may be items identified as misplaced within an inventory environment, high priced items moving with that environment, items identified by a customer for purchase, items identified for shipping to a customer, items identified by an inventory management system for removal from shelves, items that is a customer using a presentation generator is to locate, locations a customer using a presentation generator is to go find within a retailer environment, etc. For example, the server 142 may communicate RFID tag data to the presentation generator 102 over the network 144, and the presentation generator 102 may communicate that RFID tag data to the RFID reader 130 to search for the corresponding RFID tag and flag to the presentation generator 102 when the RFID tag has been identified.

In any event, an RFID tag positioning locator 132 communicates with the RFID reader 130 and determines a location of the identified RFID tags, for example by determining signal strength of an RFID signal from the RFID tag and from phase data provide by the RFID tag, when phase data is provided. The position information is communicated and with RFID tag information to the image generator 106, which generates an image to identify the location of the RFID tag to the user, in particular to identify the location of the RFID tag in an augmented reality display.

In exemplary embodiments, the elements of the presentation generator 102 are implemented by hardware, software, firmware, and/or any combination of hardware, software and/or firmware. In some examples, one or more of the elements is implemented by a logic circuit. As used herein, the term “logic circuit” is defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations. Some example logic circuits are hardware that executes machine-readable instructions to perform operations. Some example logic circuits include a combination of specifically configured hardware and hardware that executes machine-readable instructions.

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) can be stored. Further, as used herein, each of the terms “tangible machine-readable medium,” “non-transitory machine-readable medium” and “machine-readable storage device” is expressly defined to exclude propagating signals. That is, as used in any claim of this patent, a “tangible machine-readable medium” cannot be read to be implemented by a propagating signal. Further, as used in any claim of this patent, a “non-transitory machine-readable medium” cannot be read to be implemented by a propagating signal. Further, as used in any claim of this patent, a “machine-readable storage device” cannot be read to be implemented by a propagating signal.

Additionally, as used herein, each of the terms “tangible machine-readable medium,” “non-transitory machine-readable medium” and “machine-readable storage device” is expressly defined as a storage medium on which machine-readable instructions are stored for any suitable duration of time (e.g., permanently, for an extended period of time (e.g., while a program associated with the machine-readable instructions is executing), and/or a short period of time (e.g., while the machine-readable instructions are cached and/or during a buffering process)).

FIGS. 2A and 2B illustrate an example augmented reality assembly 200 that may implement the example augmented reality assembly 100 of FIG. 1. The example augmented reality assembly 200 includes a presentation generator 202 and an example head mount 204. The example presentation generator 202 houses or carries components configured to generate, for example, an audiovisual presentation for consumption by a user wearing the augmented reality assembly 200.

FIG. 3 illustrates the augmented reality assembly 200 mounted to a head 300 of a user.

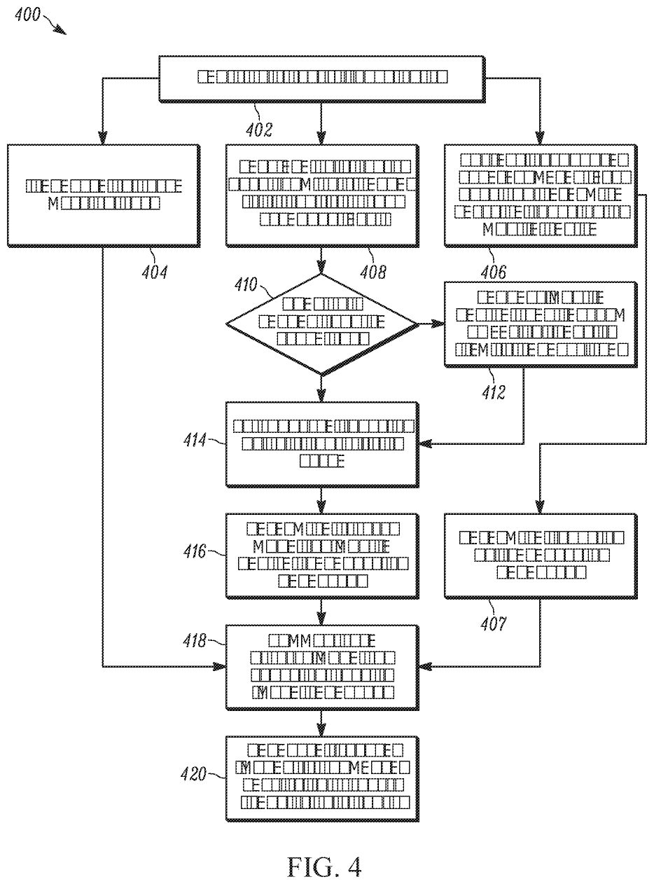

FIG. 4 is a flowchart of an example method 400 of displaying an RFID tag using an augmented reality assembly, such as the assembly 100. At a block 402 the presentation generator 102 begins a process of locating one or more RFID tag(s). For example, one or more RFID tags may be identified to the presentation generator by server 142. At a block 404, the presentation generator accesses the camera subsystem 128 and captures real-time video of a field of view of an inventory environment, within which a user is moving. The map generator 134 processes the received video and determines physical features such as the depth location of various objects in the field of view.

At a block 406, the presentation generator retrieves data from the gyroscope 124 and the accelerometer 127 and provides that information to the map generator 134, which at a block 407, determines the location of the presentation generator in relationship to a frame of reference, in relationship to the physical features identified by the block 404, and/or in relationship to RFID tags identified using block 408. At the block 408, RFID reader 130 retrieves RFID tag data from one or more RFID tags, where the RFID tag data may include the Tag ID, signal strength, user defined data, brand ID information, retailer defined data, etc., for each RFID tag.

To allow for triangulation of the exact location of the RFID tag, a block 410 determines from the received RFID tag data whether the RFID reader 130 is collecting phase data for the RFID tags. If not, then exact triangulation of the RFID tag is not possible, and the presentation generator will send a message to the user, via block 412, instructing the user to perform an initial visual sweep of a general area to visually identify where the RFID tag is located. In some examples, the block 412 may instruct the presentation generator to generate a “fuzzy” shaped or “hazy” or partially “transparent” graphic on an augmented reality display to visually indicate to a user the general location of an RFID tag but also to visually indicate that the exact location of the RFID tag cannot be determined. In such examples, the presentation generator may present the user with an option to use an input device to tag a location within the augmented reality display where the user believes the RFID is located based on that graphic. If phase data is collected, then the map generator, at a block 414, triangulates the exact location of the RFID tag and determines the position of the RFID tag in relationship to the physical features identified and in relationship to the location of the presentation generator. It is noted that as the RFID reader 130 continues to receive data from the RFID tag, the RFID reader may perform signal processing to more accurately and more quickly track the RFID tag, processing such as smoothing and averaging of the received signal.

Once the RFID tags are identified and their locations determined, at a block 416 the map generator determines an augmented reality display mode for visually displaying the location of the RFID tags. At a block 418, the map generator communicates the augmented reality display mode selection and the location data for the RFID tag from blocks 408, 410, 412, and 414, the physical features from block 406, and location information from block 407 to the image generator 106. The image generator 106, at a block 420, generates one or more graphics to be displayed in an augmented reality display to the user. The one or more graphics may be icons, bounded boxes, letters, colors, or other visual indicators for identifying the location of the RFID tag in the inventory environment.

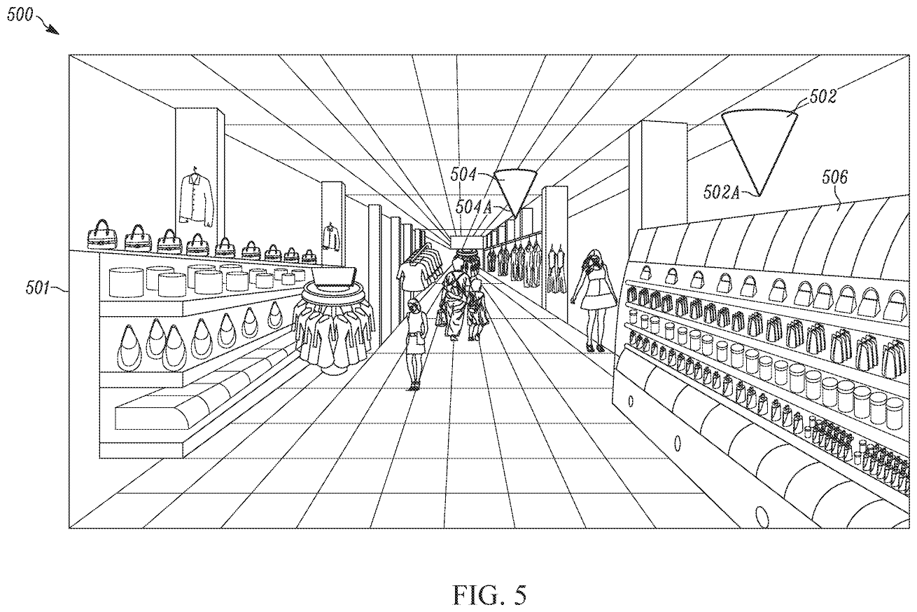

FIG. 5 illustrates an example augmented reality display 500 provided by a presentation generator, in accordance with an example. The display 500 is of an inventory environment, in particular, a retail environment. In the illustrated example, the presentation generator allows the user to see the actual inventory environment 501, e.g., through lens of the head mount unit. The augmented reality display, however, depicts two images, in the form of graphic cones that are shown hovering over the identified location of two RFID tags. A first graphic cone 502 provides a near visualizer, and a second graphic cone 504 provides a far visualizer. Each of the cones 502, 504 are differently sized and positioned within the augmented reality display to indicate the relative location of the RFID tag in the inventory environment 501. The near cone 502, for example, is larger than the far cone 504. Furthermore, the cones are positioned relative to physical features identified in the inventory environment to provide more accurate indications of location. For example, a map generator may identify physical features in the inventory environment, such as shelving 506. In the display 500, as shown, the RFID tag corresponding to graphic cone 502 is located behind the shelving 506. As such, the map generator, based on relative position of the RFID tag and the shelving 506, as well as the size of the shelving 506, instructs the image generator to generate the cone 502 at a size and locate it at a position high enough in the display 500 to allow the user to visualize where the RFID tag is within the inventory environment, even though the exact location of the RFID is hidden behind the shelving. Further, the location of a tip 502A of the cone 502 is positioned to accurately indicate the location of the corresponding RFID tag. In some examples, the graphics 502, 504 may be displayed in different colors from one another for quicker identification. Further, the image generator 106 may adjust the color intensity, opacity, shading, etc. of each graphic, as the presentation generator moves closer or further away from the corresponding RFID tags. In some examples, the image generator 106 can animate the graphic to indicate changes in relative location, such as pulsating the graphic as the presentation generator gets closer or moves further away, or changing the speed of that pulsating to indicate changes in relative location.

As the presentation generator continually tracks the location of the RFID tag relative thereto, the presentation generator, in particular the map generator instructing the image generator, continually adjusts the size, location, color intensity, animations, etc. of the graphic to indicate changes in relative location.

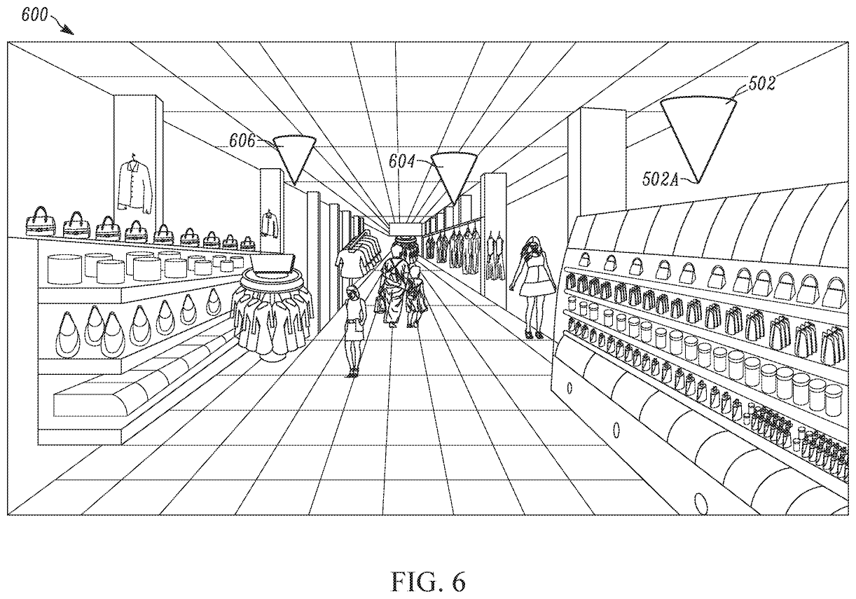

FIG. 6 illustrates an augmented reality display 600 showing three different graphics 602, 604, and 606, identifying three different RFID tags, located at a near distance, a medium distance, and a far distance, relatively.

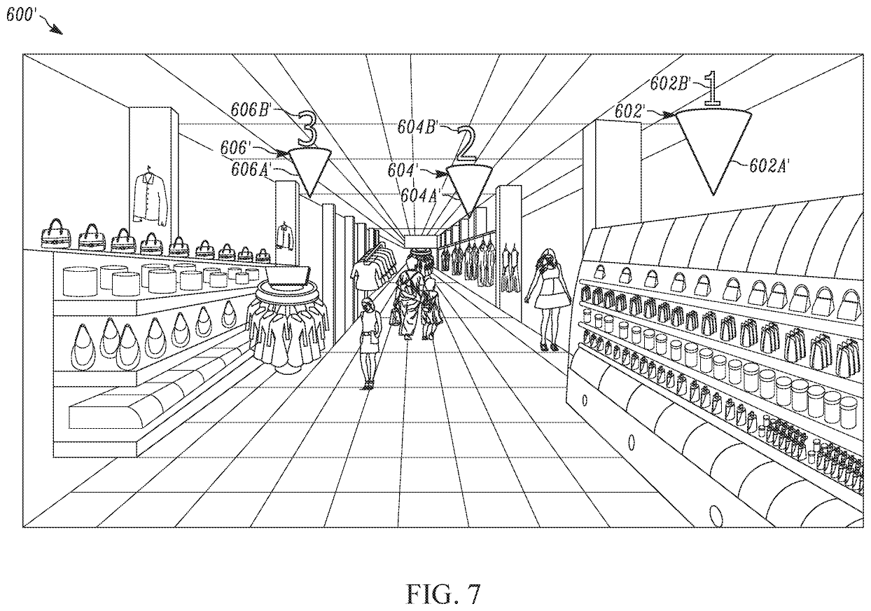

FIG. 7 illustrates the reality display 600′ showing the three different graphics 602′, 604′, and 606′ similar to those of FIG. 6, but where each graphic is a multiple tag image, including respective cones graphics 602A′, 604A′, 606A′, and above each cone a numerical graphic 602B′, 604B′, and 606B′. These multiple tag images are generated by the image generator, in response to instructions from the map generator. In the illustrated example, the map generator determines the location of each of the RFID tags and instructs the image generator where the graphic images are to be located. The map generator has also determined the type of graphic image. Further still, the map generator has determined that the graphic images are to have a relative ranking between them, so that the relative ranking is displayed on the presentation generator. The rankings can be depicted by changing the graphic images, changing the colors, or changing other elements. In illustrated example, a numerical indicator identifying the ranking has been generated, with the nearest RFID tag having a graphic image labeled with a “1”, the next closest RFID tag having a graphic image labeled “2”, and the furthest labeled “3”, where these relative numerical graphics may change as the presentation generator moves closer or further away to or from the respective RFID tags.

Whereas the augmented reality displays 600 and 600′ have been generated using augmented reality glasses, such the augmented reality assembly 200, FIG. 8 illustrates another example presentation generator in the form of a handheld scanner 800. The handheld scanner 800 has a keypad 802 and a display 804, such as, as digital monitor displaying a scene captured by a camera subsystem. In the illustrated, the display 804 depicts a digital rendition of a portion of shelving 806 in a retail environment. The digital rendition has been augmented by the overlay of an image 808 identifying an RFID tagged item on the shelving 806. In the illustrated the image 808 is shaped as a bounding box, that provides an outline around the time corresponding to the RFID tag. For example, the map generator may be configured to identify the actual item corresponding to the RFID tag and instruct the image generator to generate an image that depicts a shape of the actual item. In some examples, the shape of the item is identified to the presentation generator by the server 142.

FIG. 9 shows the handheld scanner 800 depicting two different images 808 and 810, where image 808 identifies an item having an RFID tag identifying the item as an expired produce item, whereas image 810 identifies an item having an RFID tag identifying the item as a non-expired produce item.

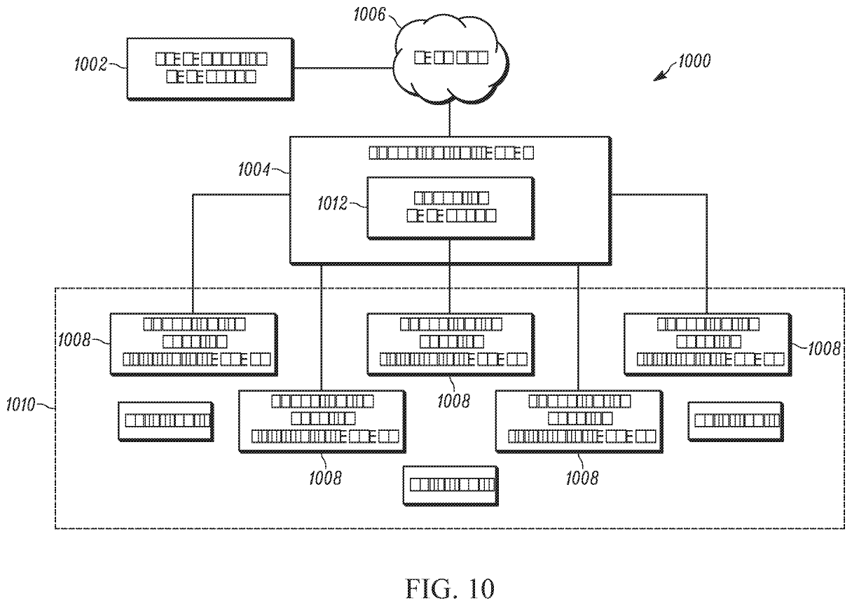

FIG. 10 illustrates an augmented reality assembly system 1000 having a presentation generator 1002, which may be similar to the presentation generator 102. The presentation generator 1002 communicates with a locationing server 1004 through a wireless network 1006. The locationing server 1004 communicates with a plurality of locationing stations 1008 that are positioned throughout an inventory environment 1010. In exemplary embodiments, these locationing stations 1008 are RFID readers that detect and track RFID tags within the environment 1000. Other types of locationing stations that may be used includes optical locationing stations, RF locationing stations, infrared locationing stations, and/or acoustic locationing stations. The locationing server 1004 includes a location generator 1012 that receives location information from each of the stations 1008 and determines a location of one or more RFID tags (RFID TAG1, RFID TAG2, RFID TAG3) within the environment. The server communicates that locationing information to the presentation generator 1022. That is, the illustrated example, the locationing of items to identify in the augmented reality display is performed by a centralized server. This allows for identification of items over a larger geographic area, including those items out of range of the presentation generator detection. In some examples, the presentation generator synchronizes identification with the server, such that items are detected and tracked by one or both of the presentation generator 1022 and the server 1004 depending on the location of the item.

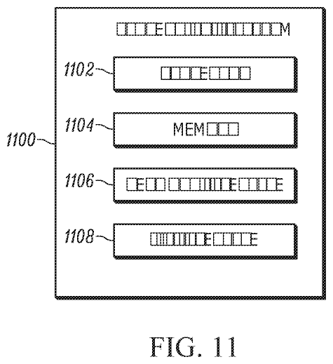

FIG. 11 is a block diagram representative of an example logic circuit that may be utilized to implement, for example, the example presentation generator 102, 1002 and/or server 1004. The example logic circuit of FIG. 11 is a processing platform 1100 capable of executing machine-readable instructions to, for example, implement operations associated with, for example, the presentation generators herein.

The example processing platform 1100 includes a processor 1102 such as, for example, one or more microprocessors, controllers, and/or any suitable type of processor. The example processing platform 1100 includes memory 1104 (e.g., volatile memory, non-volatile memory) accessible by the processor 1102 (e.g., via a memory controller). The example processor 1102 interacts with the memory 1104 to obtain, for example, machine-readable instructions stored in the memory 1104. Additionally or alternatively, machine-readable instructions may be stored on one or more removable media (e.g., a compact disc, a digital versatile disc, removable flash memory, etc.) that may be coupled to the processing platform 1100 to provide access to the machine-readable instructions stored thereon. In particular, the machine-readable instructions stored on the memory 1104 may include instructions for carrying out any of the methods described herein.

The example processing platform 1100 further includes a network interface 1106 to enable communication with other machines via, for example, one or more networks. The example network interface 1106 includes any suitable type of communication interface(s) (e.g., wired and/or wireless interfaces) configured to operate in accordance with any suitable protocol(s). The example processing platform 1100 includes input/output (I/O) interfaces 1108 to enable receipt of user input and communication of output data to the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for displaying an image identifier associated with an item in an inventory environment, the system comprising:
an augmented reality assembly comprising
a presentation generator configured to display an augmented reality display a user, the presentation generator comprising,
a tag reader configured to locate and track a tag associated with the item,
a tag locationer configured to determine a location of the tag in a three-dimensional (3D) space,
a presentation generator locationer configured to determine a location of the presentation generator in the 3D space,
a map generator configured to generate a special mapping of the location of the tag in the 3D space,
an image generator configured to generate the image identifier, and
a display;
a memory configured to store computer executable instructions; and
a processor configured to interface with the memory, and configured to execute the computer executable instructions to cause the augmented reality assembly to,
identify the tag in the inventory environment,
determine a location of the tag in the inventory environment,
generate an image identifier, and
display the image identifier in an augmented reality display, where the image identifier identifies the location of the tag in the inventory environment.

2. The system of claim 1, where computer executable instructions, when executed, cause the presentation generator to:
determine the type of image identifier based on identification data for the tag.

3. The system of claim 1, where computer executable instructions, when executed, cause the presentation generator to:
determine the type of image identifier based on the location of the tag.

4. The system of claim 1, where computer executable instructions, when executed, cause the presentation generator to:
determine an augmented reality display mode based on the location of the tag.

5. The system of claim 1, where computer executable instructions, when executed, cause the presentation generator to:
determine an augmented reality display mode based on identification data for the tag.

6. The system of claim 1, wherein the tag reader is an radio-frequency identification (RFID) tag reader and the tag is an RFID tag associated with the item.

7. The system of claim 1, wherein the augmented reality assembly comprises augmented reality glasses configured to be worn by a user.

8. The system of claim 1, wherein the augmented reality assembly comprises a handheld scanner having a digital display for displaying the augmented reality display.

9. The system of claim 8, wherein the augmented reality assembly comprises a camera subsystem configured to capture image data of the inventory environment, and where the computer executable instructions, when executed, cause the presentation generator to display the image identifier in an augmented reality rendition of the captured image data, as the augmented reality display.

10. The system of claim 1, where the computer executable instructions, when executed, cause the presentation generator to:
identify a plurality of tags in the inventory environment;
determine a location of each of the plurality of tags in the inventory environment;
generate an image identifier for each of the plurality of tags; and
display each of the image identifiers in an augmented reality display, where each image identifier identifies the location of a respective tag in the inventory environment and where each of the image identifiers is different from each other image identifier.

11. A system for displaying an image identifier associated with an item in an inventory environment, the system comprising:
a locationing server communicating with one or more locationing stations positioned within an inventory environment, each locationing station configured to detect a tag associated with the item within the inventory environment, the locationing server configured to determine a location of the tag within the inventory environment; and
an augmented reality assembly communicatively coupled to the locationing server to receive location data for the tag, the augmented reality assembly comprising:
a presentation generator configured to display an augmented reality display a user, the presentation generator comprising,
a presentation generator locationer configured to determine a location of the presentation generator in a 3D space of the inventory environment,
a map generator configured to generate a mapping of the location of the tag in the 3D space,
an image generator configured to generate the image identifier, and
a display;
a memory configured to store computer executable instructions; and
a processor configured to interface with the memory, and configured to execute the computer executable instructions to cause the augmented reality assembly to,
determine a location of the tag in the 3D space,
generate an image identifier, and
display the image identifier in an augmented reality display of the 3D space, where the image identifier identifies the location of the tag in the inventory environment.

12. The system of claim 11, where computer executable instructions, when executed, cause the presentation generator to:
determine the type of image identifier based on identification data for the tag and/or the location of the tag in the inventory environment.

13. The system of claim 11, where computer executable instructions, when executed, cause the presentation generator to:
determine an augmented reality display mode based on the location of the tag or based on identification data for the tag.

14. The system of claim 11, wherein the locationing stations are each radio-frequency identification (RFID) tag readers and the tag is an RFID tag associated with the item.

15. The system of claim 11, wherein the augmented reality assembly comprises augmented reality glasses configured to be worn by a user.

16. The system of claim 1, wherein the augmented reality assembly comprises a handheld scanner having a digital display for displaying the augmented reality display.

17. An augmented reality display system comprising:
a display configured to display an augmented reality rendition of an inventory environment to a user;
an RFID tag reader configured to detect and track one or more RFID tags in the inventory environment;
a memory configured to store computer executable instructions; and
a processor configured to interface with the memory, and configured to execute the computer executable instructions to cause the augmented reality display system to,
in response to detection and tracking of one or more RFID tags, generate for each detected RFID tag an image identifier, and
generating the augmented reality rendition of the inventory environment having the image identifier for each detected RFID tag, where the location of the image identifier indicates a location of the detected RFID tag in the inventory environment.

18. A computer-implemented method for displaying an image identifier associated with an item in an inventory environment, the method comprising:
in an augmented reality display assembly,
detecting and tracking a RFID tag in the inventory environment,
generating an image identifier for the RFID tag, and
generating an augmented reality display of the inventory environment, where the image identifier is placed within the augmented reality display to indicate a location of the detected RFID tag in the inventory environment.
